(19) United States
(12) Patent Application Publication
(10) Pub. No.: US 2009/0129891 A1
(43) Pub. Date: May 21, 2009

(54) Support Pin Fixed by Staking, and Back Plate for Flat Display Having the Support Pin Installed thereon

(76) Inventor: Takashi Shigesada, Osaka (JP)

Correspondence Address: JORDAN AND HAMBURG LLP, 122 EAST 42ND STREET, SUITE 4000, NEW YORK, NY, 10168, US

(21) Appl. No.: 12/084,000

(22) PCT Filed: Oct. 30, 2006
(86) PCT No.: PCT/JP2006/321668

§ 371 Date: Apr. 23, 2008

(30) Foreign Application Priority Data
Oct. 28, 2005 (JP) 2005-314513

(51) Int. Cl. F16B 19/08

(52) U.S. Cl. 411/501

(57) ABSTRACT

A support pin mainly composed of a fitting part fitted into a hole in a workpiece, a flange part (head part) formed at one end of the fitting part, and a projected shaft formed at the other end of the fitting part. The fitting part is larger in diameter than the projected shaft, and an annular recess is formed in the fitting part. A portion of the fitting part is formed as a staking part, and the portion is located on the outside of the annular recess. The annular recess has a bottom part and a tilted inner peripheral surface. When the support pin is held and pressed by both the die and the punch of a press device, the flange part digs into the front surface of the workpiece and the staking part digs into the rear surface of the workpiece.

### TECHNICAL FIELD

The present invention relates to a support pin (stud pin) fixed by staking, for example, used for holding plates in an almost parallel posture, and to a back plate for a flat display panel to which the support pin is inserted.

### BACKGROUND ART

In recent years, as a display for displaying an image, a plasma display panel and a liquid crystal display panel are becoming the mainstream in place of a cathode-ray tube display, and flat display panels of other systems such as an organic EL system are also becoming practically used. One of features of the flat display panels is that the panels can be easily formed large. The size of a television receiver is remarkably increasing by the appearance of the flat display panels.

For example, in a plasma display panel as one of flat display panels, as roughly shown in FIG. 10A, a back plate S made by a metal plate such as steel plate or an aluminum plate is disposed at the rear side, and a circuit board P is attached to the back plate S (the back plate S is also called a chassis). In this case, as shown in FIGS. 10B and 10C, a number of metal support pins 20 are inserted in the back plate S and, by using the support pins 20, the circuit board P is attached to the back plate S by a method of screwing or the like. There are a plurality of kinds of support pins 20 such as a support pin having only just the role of a spacer and a support pin in which an internal thread is formed and having a role of a nut.

The support pin 20 is fixed to the back plate S by staking. As conventional techniques of a support pin which can be fixed to a work (plate member) such as the back plate S for a plasma display panel by staking, for example, patent documents 1 to 5 exist. In any of support pins of the patent documents 1 to 5, a number of, for example, angular flanges are formed along the circumferential direction at one end of the shaft (a group of the flanges can be also called the head). By making the flanges sink into the work, the shaft is held so as not to come off in one direction and so as not to be rotatable.

The shaft has to be held so as not to come off in the other direction. In each of the support pins of the patent documents 1 and 2 as come-off preventing means, an annular groove is formed in a base portion close to the flanges in the shaft, so that a part of the work enters the annular groove by staking.

In patent documents 3 to 5, the diameter of a fitting part which is fit in a work in the shaft is larger than that of the other part. An annular groove having a triangle shape in section is formed in the end face of the fitting part, and a part on the outside of the annular groove in the fitting part serves as a staking part. The staking part is staked to the work from the side opposite to the flanges. As a result, the shaft is prevented from coming off in the other direction. The support pin in the patent document 3 has both the annular groove and the staking part.

A support pin which is fixed by staking but whose flanges (head) do (does) not sink in the work is also proposed. Examples of this type are disclosed in patent documents 6 to 9.
Patent document 1: Japanese Unexamined Patent Application Publication No. 2004-316784
Patent document 2: Japanese Unexamined Patent Application Publication No. 2003-322128
Patent document 3: Japanese Unexamined Patent Application Publication No. H07-269537
Patent document 4: Japanese Unexamined Patent Application Publication No. 2004-197762
Patent document 5: Japanese Unexamined Patent Application Publication No. 2003-247520
Patent document 6: Japanese Examined Utility Model (Registration) Application Publication No. Sho 35-34129
Patent document 7: microfilm of Japanese Unexamined Utility Model (Registration) Application Publication No. Sho 64-57409
Patent document 8: Japanese Examined Utility Model (Registration) Application Publication No. Sho 35-712
Patent document 9: Japanese Examined Utility Model (Registration) Application Publication No. Sho 48-44536

### DISCLOSURE OF THE INVENTION

### Problems to be Solved by the Invention

A support pin is generally manufactured by using, as a material, a wire member (steel wire or aluminum wire). At the time of manufacturing a support pin, the flanges can be easily manufactured by deforming process of applying a press force in the axial direction by a mold. However, when the annular grooves described in the patent documents 1 to 3 are formed by plastic processing, a problem arises such that a complicated mold apparatus is necessary. When rolling process or cutting process is used, a problem occurs such that the number of processes increases and the cost becomes higher.

Theoretically, it can be said that formation of the annular groove in the end face of the fitting part as in the patent documents 4 and 5 is easily realized by applying a press force in the axial direction with a mold (molding tool). In reality, however, when the sectional shape of the annular groove is a triangle shape as in the patent documents 4 and 5, to form the annular groove, a sharp edge part has to be formed in the processing mold. In this case, during use, the edge part is nicked soon. Therefore, it is extremely difficult to mass-produce support pins having the forms as in the patent documents 4 and 5 at low cost.

In the case of attaching a support pin to a work such as the back plate S, the flanges are strongly pressed (pressure-pressed) by a punch in a state where the projected part of the support pin is fit in a cylindrical die (jig). Since a slight gap exists between the inner periphery of the die and the projected part of the conventional support pin, a phenomenon such that a part of the work or the support pin enters the gap in the staking process and becomes as a burr occurs. Due to this, the support pin cannot be come off from the die. To prevent the situation, for example, the inside diameter of the hole in the die has to be increased considerably large. It causes another problem such that the axis of the support pin tends to be deviated.

As described above, the conventional support pins are not always satisfactory, and there is still room for improvement. The present invention has been achieved in order to improve such the present circumstances.

### Means for Solving the Problem

The present invention is mainly directed to a support pin. The support pin has, as large elements, a fitting part 2 fit to a hole S1 opened in a work S made by a metal plate, a flange part 3 formed at the periphery of one end of the fitting part 2 and overlapping one of surfaces of the work S, and a projected shaft 5 provided integrally with a part on the side opposite to the flange part 3 in the fitting part 2.

In the present invention, the diameter of the projected shaft 5 is smaller than that of the fitting part 2 so that an annular end surface is exposed in a part on the side opposite to the flange part 3 in the fitting part 2. An annular recess 6 is formed in the annular end surface in the fitting part 2 in a state where an inner peripheral surface of the annular recess 6 coincides with an outer peripheral surface of the projected shaft 5. An outer part of the annular recess 6 is deformed when it is pinched in an axial direction so that it becomes a staking part 4 which is partly spread outward. Further, when the fitting part 2 and the work S are pinched in the axial direction by a die and a punch in a state where the fitting part 2 is fit in the hole S1 in the work S, all or most of the fitting part 2 including the flange part 3 and the staking part 4 sink in the work S.

The annular recess 6 has a bottom face 6a continued to the outer periphery of the projected shaft 5 and a tilted inner peripheral surface continued from the bottom face 6a and becomes shallower toward the outer periphery of the staking part. The bottom face 6a and the tilted surface are continued indirectly in a recessed state toward the tip of the projected shaft in vertical section view, so that the annular recess 6 has a trapezoidal shape or a shape close to the trapezoidal shape in vertical section view.

Further, when an overall length of the fitting part 2 is L0, a thickness of the work S is T1, a length in the axial direction from a top surface of the flange part 3 to the bottom face 6a of the annular recess 6 is L2, and a length in the axial direction from a seating surface of the flange part 3 to the tip of the staking part 4 is L1, L0 is larger than T1 and L2, L2 is almost equal to or smaller than T1, and L1 is larger than T1. The relations of L0, T1, and L2 are approximately expressed as L0>T1≧L2 as a preferable configuration. A particularly preferable relation of T1 and L2 is expressed as T1>L2.

In the present invention, various modes can be employed for the bottom face of the recess 6. In a preferred mode, the bottom face 6a of the recess 6 is flat, so that a vertical-sectional shape of the recess 6 is an almost trapezoidal shape.

The present invention also includes a back plate for a plasma display panel, wherein a number of the support pins 1 according to claim 1 or 2 are attached by staking. All or most of the fitting part 2 including the flange 3 and the staking part 4 in the support pin 1 sink in the back plate.

### Effects of the Invention

A method of attaching the support pin according to the present invention is similar to that of attaching a conventional one. A work is supported with a cylindrical die to which the projected shaft is fit and, in that state, the flange part (the top face) is strongly pressed by a punch. A compressive force in the axial direction acts on the flange part, the fitting part, and the staking part, the staking part is deformed, and the flange part sink in the work.

In the support pin of the present invention, in a state where the fitting part is inserted in a hole in the work and the flange part overlaps one of the surfaces of the work, the periphery of the staking part is exposed from the other surface of the work. Consequently, the pressing force acts on the staking part from the beginning in an attaching process (process of staking the support pin to the work). Thus, the staking part is deformed so that a part of it spreads outward in the radial direction so as to bury the annular recess, and occurrence of a burr can be prevented.

Since a valley such as a flat part or a circular arc part exists in the annular recess, the deformed staking part can be reliably absorbed in the annular recess, and occurrence of a burr can be prevented.

As described above, in the support pin of the present invention, occurrence of a burr in the process of attaching the support pin to the work can be prevented. Consequently, the support pin can be easily pulled out from the die after the attachment without taking a special measure such that the diameter of the hole in the die is set to be large. Therefore, attachment of the support pin to a work can be performed efficiently, and the percent defective of works with support pins (product) can be conspicuously lowered.

In the support pin of the present invention, the annular recess for forming the staking part is constructed in such a manner that the bottom part and the tilted surface continue in a recess shape toward the tip of the projected shaft. Consequently, the outer peripheral surface of the support part and the bottom part in the annular recess do not cross each other at an acute angle in vertical cross section. It is therefore unnecessary to form a sharp edge in a mold in a process of the annular recess by plastic-process (forming) using a mold (edge). Thus, the durability of the mold can be improved dramatically and, as a result, the support pins can be mass-produced at low cost.

Further, by specifying the dimensions of the support pin as in the claim, the staking part can completely sink in the surface of the work (the back side opposite to the flange part) or can be hardly projected. Therefore, the staking part after the process can be easily prevented from becoming hindrance or spoiling the beauty.

In the case where the work is a back plate for a display panel, when a burr remains in the back plate, there is the possibility that the burr is detached and exerts an adverse influence on a product (for example, the burr drops on the circuit board and an adverse influence of causing short circuit is executed). However, when a back plate is constructed by inserting the support pin of the present invention, a burr caused by inserting the support pin does not occur. Thus, the present invention can contribute also to improve the quality of a final product (display panel).

Since the adhesion of adhered surfaces of the support pin and the back plate is high, it is estimated that the current passage characteristic between the support pin and the back plate is also stable. Consequently, it can be said that the electric characteristic is excellent, for example, when the back plate is used for the earth. Further, it is estimated that integrity between the support pin and the back plate is higher than that in a conventional product, and the heat dissipation characteristic is therefore also excellent at the time of making heat generated by heat dissipation escape from the support pin to the back plate.

### BRIEF DESCRIPTION OF THE DRAWINGS

FIGS. 1A and 1B FIG. 1A is a front view of a support pin, and FIG. 1B is a plan view of the support pin.

FIG. 2 Partially cutaway front view of the support pin and a work.

FIGS. 3A and 3B FIG. 2A is a general view showing a support pin attaching process, and FIG. 2B is a partial enlarged cross section of FIG. 2A.

FIGS. 4A and 4B Diagrams showing action of a staking process.

FIG. 5 Partially cutaway front view showing a state where the staking process is finished.

FIGS. 6A and 6B FIG. 6A is a diagram showing a pulling process, and FIG. 6B is a diagram showing a comparative example.

FIGS. 7A to 7F Diagrams showing second to seventh embodiments.

FIG. 8 Diagram showing an eighth embodiment.

FIGS. 9A to 9F Diagrams showing other comparative examples (conventional techniques).

FIG. 10A to 10C FIG. 10A is a schematic perspective view of a plasma display, FIG. 10B is a partial schematic front view showing a state where a circuit board is attached to a back plate, and FIG. 10C is a partial schematic front view showing a state where the back plate and the board are separated from each other.

### DESCRIPTION OF REFERENCE NUMERALS

1 support pin
2 fitting part
3 flange part
4 staking part
5 projected shaft
6 annular recess
6a bottom part
4a tilted surface in annular recess (tilted surface in staking part)
7 die
8 punch
S back plate for flat display panel as an example of work

### BEST MODES FOR CARRYING OUT THE INVENTION

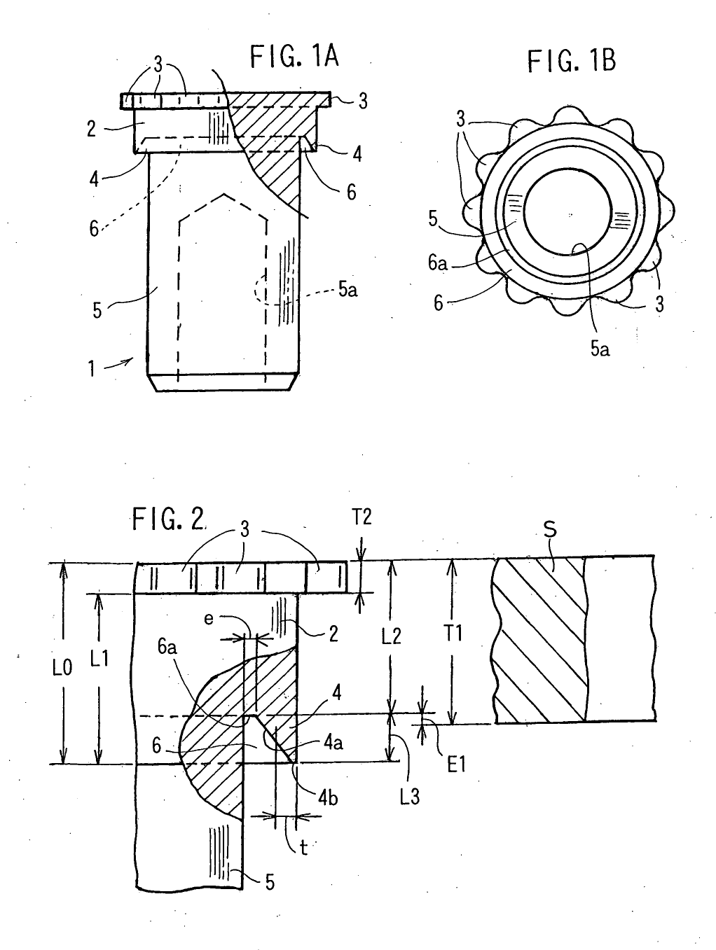

Embodiments of the present invention will be described with reference to the drawings. The embodiments are applied to a support pin to be fit to a back plate S for a plasma display panel (obviously, it can be also used for other various works) First, a first embodiment will be described with reference to FIGS. 1A and 1B to FIGS. 6A and 6B.

### (1) Structure of Support Pin

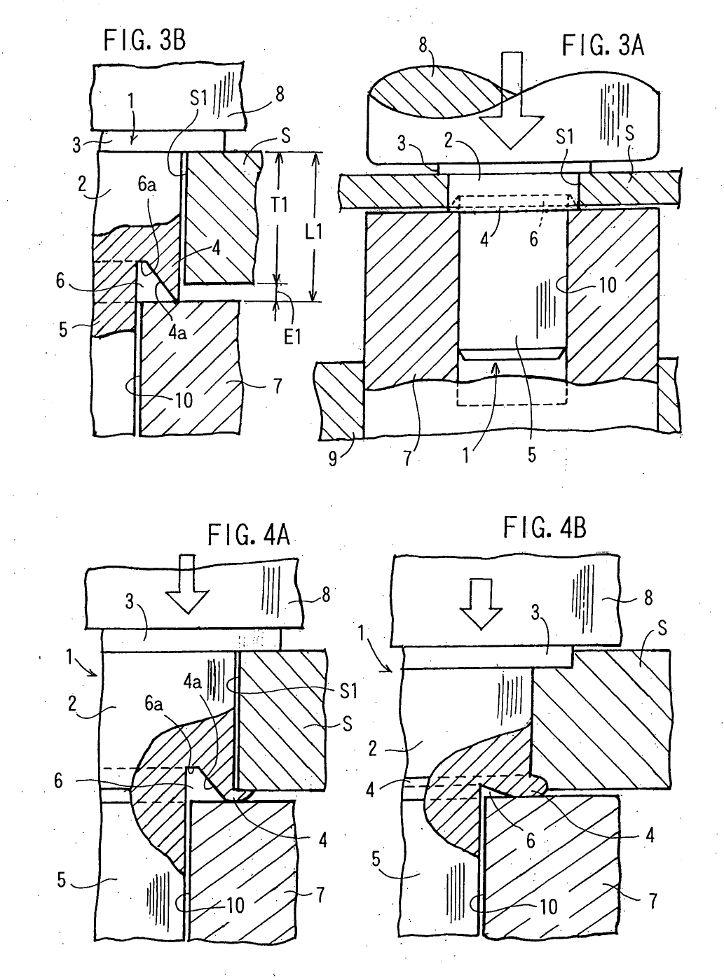

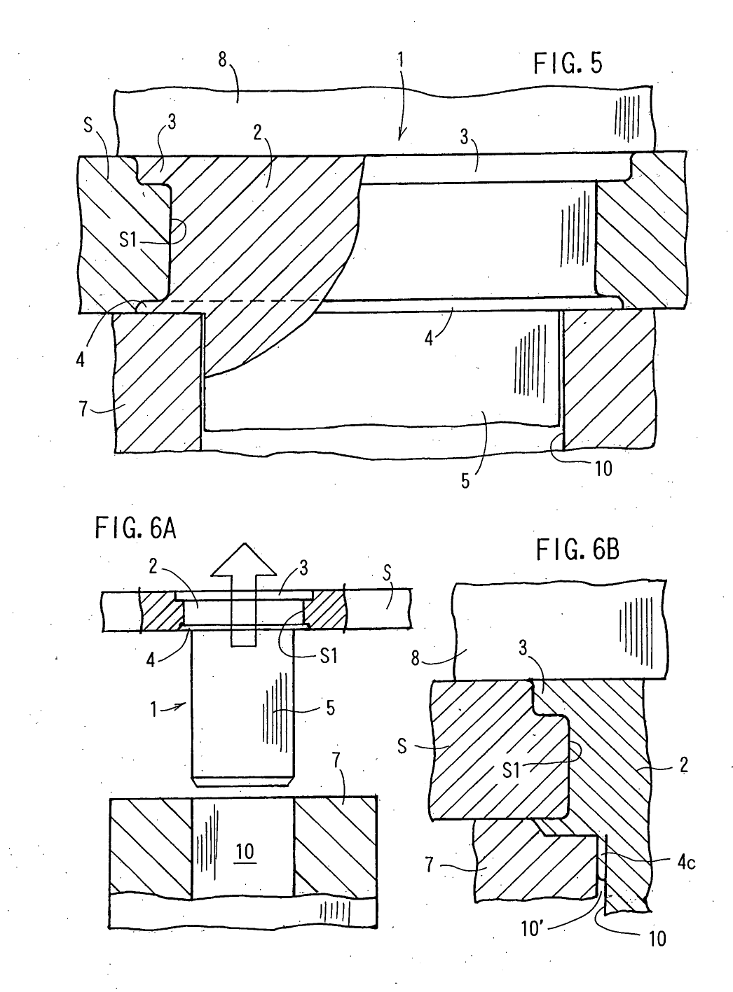

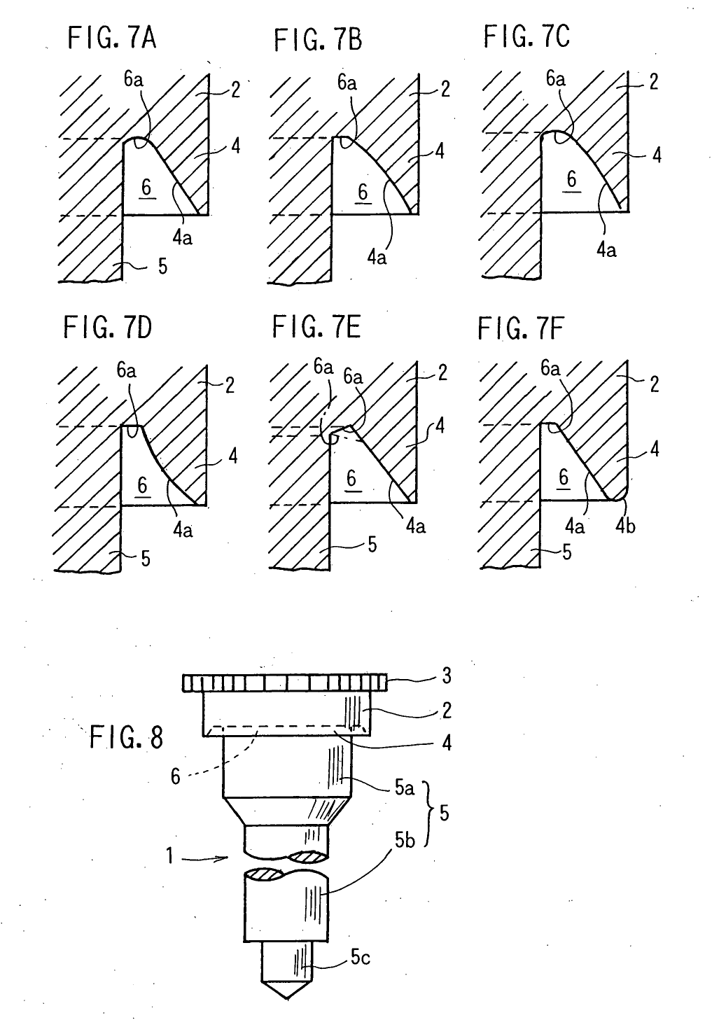

A support pin 1 is manufactured using a metal round bar made of aluminum, steel, or the like and has, as shown in FIGS. 1A and 1B and FIG. 2, a fitting part 2 which is fit in a hole in the back plate S, a number of flange parts 3 formed at the periphery of one end of the fitting part 2 and overlapping one of the surfaces of the back plate S, a staking part 4 formed integrally with a part on the side opposite to the flange parts 3 in the fitting part 2, and a projected shaft 5 having a diameter smaller than that of the fitting part 2. Each of the flange parts 3 is formed in an almost semicircular shape when viewed from the axial direction, and the group of the flange parts 3 are formed in the shape of flower petals. Obviously, the flange parts 3 can be formed in the other shapes such as triangle, trapezoid, and the like.

Since the diameter of the projected shaft 5 is smaller than that of the fitting part 2, an annular end face is exposed on the side opposite to the flange parts 3 in the fitting part 2. The staking part 4 is formed by creating an annular recess 6 in an end face of the fitting part 4.

In this case, the inner peripheral surface of the annular recess 6 matches with the outer peripheral surface of the projected shaft 5, and a bottom part 6a is formed as a flat face (a ring-shaped flat face almost parallel with a plane crossing the projected shaft 5). Further, the inner peripheral surface 4a of the annular recess 6 (in other words, the inner peripheral surface of the staking part 4) is a tilted surface whose depth decreases from the projected shaft 5 to the outside in the radial direction (in other words, toward the outer surface of the fitting part 2). The inner peripheral surface 4a of the annular recess 6 has a profile of a straight line in vertical section. Therefore, the annular recess 6 has an almost trapezoidal shape in the vertical cross section.

Specifically, thickness “t” in the radial direction of the staking part 4 is the largest in the base part of the flange part 3 and gradually changes so as to the smallest at the tip far from the flange part 3. Plainly speaking, in the embodiment, the staking part 4 is formed in a shape close to a triangle shape in cross section (right-angled triangle), and a tip 4b is formed in a flat shape of very narrow width. Therefore, the sectional shape of the staking part 4 can be also regarded as a triangle very close to a trapezoidal shape. Width “e” of the bottom part 6a of the annular recess 6 is much smaller than the maximum of the thickness “t” (this will be called t′) in the radial direction of the staking part 4. However, the dimensions “e” and t′ can be arbitrarily set. According to circumstances, “e” and t′ can be set to almost the same dimensions, or “e” can be set to be larger than t′.

The bottom part 6a of the annular recess 6 and the inner peripheral surface 4a cross each other in vertical section view, and the cross angle is an obtuse angle. Therefore, as one of the features of the present invention, it can be said that an obtuse angle is formed by the bottom part 6a of the annular recess 6 and the inner peripheral face 4a in vertical section view.

As shown in FIG. 2, a length L1 of a part excluding the flange parts 3 of the fitting part 2 is larger than the thickness T1 of the back plate S only by a small length E1. As a concrete numerical value of the length E1 may be about 0.1 to 0.5 mm. The outside diameter of the projected shaft 5 of the support pin used for the back plate S of the plasma display panel is often set to about 5 to 7 mm.

As shown in FIG. 2, a length L2 from the top surface of the flange part 3 to the bottom surface of the annular recess 6 is smaller than the thickness T1 of the back plate S only by a small dimension E2. The thickness of the flange part 3 is expressed as T2, and the projection dimension in the axial direction of the staking part 4 is expressed as L3.

The overall length L0 of the fitting part 2 is larger than the thickness T1 of the back plate S. Therefore, when it is assumed that only the flange part 3 completely sinks in the back plate S, the staking part 4 protrudes partly from the back plate S. Consequently, a staking amount to be deformed is allowed in the staking part 4.

The support pin 1 can be also manufactured by cutting process but it is preferable to manufacture the support pin 1 by a forming machine using a header and a dice from the viewpoint of manufacture efficiency. That is, it is preferable to manufacture the support pin 1 by a plasticity processing. In the support pin 1 of the embodiment as means for attaching a member such as a circuit board P, an internal thread hole 5a which is open at an end face of the projected shaft 5 is formed in the projected shaft 5. Therefore, the circuit board P or the like is fixed to the end face of the projected shaft 5 via a screw. It is preferable to plastic-form the internal thread hole 5a by a rolled tap from the viewpoints of process speed and prevention of generation of chips. As described above, a support pin 1 of a type having no internal thread 5a also exists.

### (2) Staking Process

A method of attaching the support pin 1 to the back plate S is similar to conventional one. As shown in FIG. 2, the back plate S is supported by the cylindrical die 7 to which the projected shaft 5 is fit and, in this state, the flange parts 5 are strongly pressed by a punch 8. The flange parts 5 sink in the staking part 4 is deformed. The die 7 is fixed to the base plate 9. In FIG. 3 and the following diagrams, the flange parts 3 are not shown.

FIG. 4 shows a state where the parts are deformed in the staking process. This point will be described. First, in a state where the support pin 1 is set, the tip of the staking part 4 is partially projected (exposed) from the back plate S. Consequently, in the beginning of the staking process (pinching process), the tip of the staking part 4 is deformed as shown in FIG. 4A.

Specifically, since the staking part 4 has an almost triangle shape in cross section in which the width decreases toward the bottom (toward the tip) in the state shown in FIG. 4A, it is deformed so that the tip (the lower part in the diagram) of the staking part 4 escapes to the outside in the radial direction in the beginning of the staking process. That is, the staking part 4 in the thickness direction tends to escape so as to be away from the axis of the fitting part 2 (to the outside in the radial direction). Therefore, directionality of the deformation is given to the staking part 4.

When the support pin 1 is further pinched, the flange parts 3 further sink in the back plate S, and the staking part 4 is deformed so as to close the annular recess 6 and sink in the back plate S. Finally, as shown in FIG. 5, the flange parts 3 and the staking part 4 sink completely in the back plate S or slightly project to the back side of the back plate S.

Even though the flange parts 3 and the staking part 4 project partly to the back side of the back plate S, the projection is, for example, only about 0.1 mm, so that there is no problem. Depending on the kind of a work, the flange parts 3 and the stacking part 4 may project slightly to both the surface and back sides.

There is a very small gap between the inner peripheral surface of the die 7 and the outer peripheral surface of the projected shaft 5. In reality, it is impossible to eliminate the gap. If the end face of the staking part 4 is flat, as shown in a comparative example of FIG. 6B, a part of the stacking part 4 enters a gap 10′ and becomes a burr 4c. Due to this, there is the possibility that the support pin 1 does not come off from the die 7, or the burr 4c comes off after the display panel D is manufactured as a product and the adverse influence is exerted on the product. In contrast, in the present invention, the staking part 4 does not flow in the gap 10′, so that the burr 4c is not generated.

As described above, in the present invention, a part of the staking part 4 is reliably deformed so as to spread outward in the radial direction, and the staking part 4 is absorbed in the annular recess 6 and does not escape to the inner radial part of the die 7, so that occurrence of a burr can be prevented reliably. Consequently, without performing a special work such as a work of setting the hole 10 of the die 7 to be excessively large, as shown in FIG. 6A, the support pin 1 can be reliably taken out from the die 7 after the staking process.

The method of attaching the circuit board P to the back plate S by using the support pin 1 is not limited to the method of screwing, but various methods can be employed such as a method of forming an external thread at the tip of the projected shaft 5 and fixing the circuit board P by a nut screwed on the external thread, and a method of widening the tip of the projected shaft 5 by staking to fix the circuit board P.

### (3) Supplementary Remarks on Comparison Between the Present Invention and the Patent Documents

The points of the present invention and the embodiment which seem to be technically more excellent than the patent documents will be supplementarily described. Although the term “work” will be used in the following description, the reference character “S” used for the back plate in the embodiment is designated to the work. A support pin in a comparative example is shown by reference numeral 1′. Further, in the comparative example, the reference numerals in the embodiment are given to elements common to those of the foregoing embodiment.

(3)-1 Comparison with Patent Documents 1 and 2

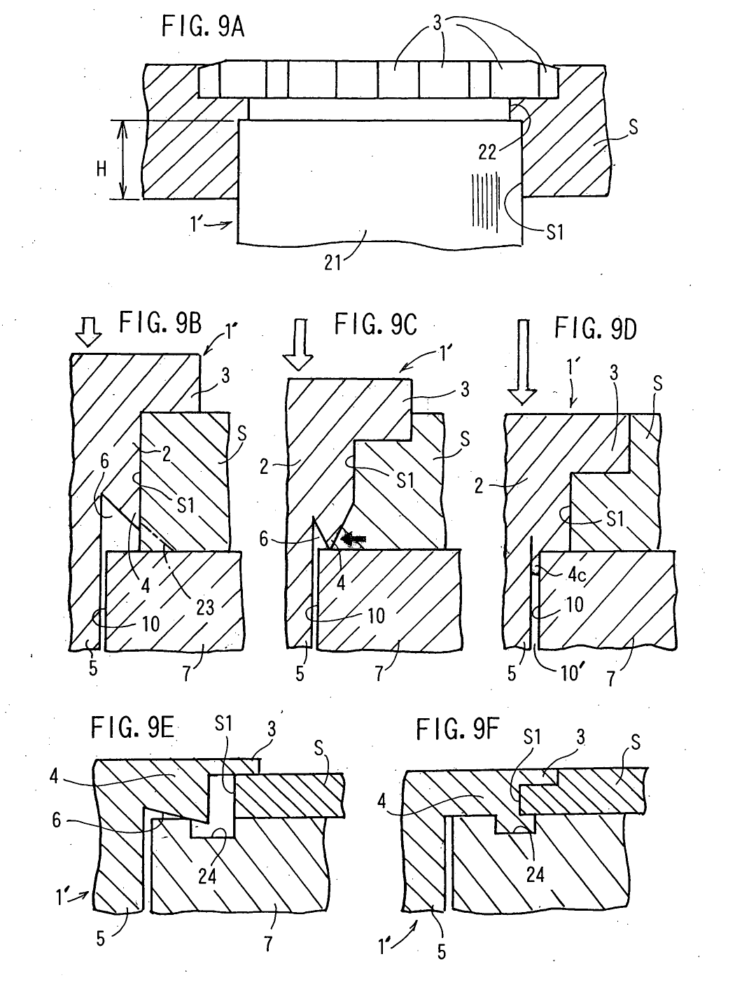

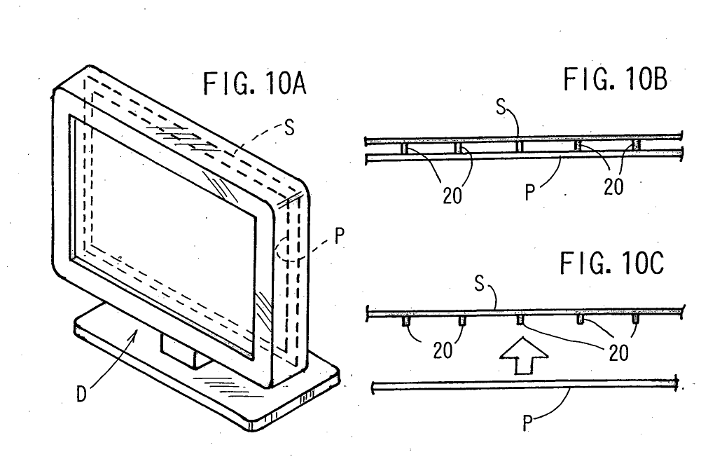

First, comparison with Patent Documents 1 and 2 will be described with reference to FIG. 9A. In a support pin 1′ of the patent documents 1 and 2, the work S enters an annular groove 22 formed in a shaft 21. On the other hand, in the case of making the work S deformed, the work S has a property such that it is easily deformed in the direction of widening the hole S1 but is not easily deformed in the direction of decreasing the inside diameter of the hole S1. Consequently, in the patent documents 1 and 2, there is the possibility that the annular groove 22 in he support pin 1′ is not filled with the work S. As a result, fastening strength may become insufficient or the electric resistance between the support pin 1′ and the work S may vary.

Since only the part around the flange parts 3 in the support pin 1′ of the patent documents 1 and 2 is held in the work, to assure the uprightness of the work S, the shaft 21 has to be fit in the hole S1 in the work S only by some height H. Therefore, in the patent documents 1 and 2, when the work S becomes thinner, the uprightness and the fastening strength of the support pin 1′ deteriorates. Due to this, it can be said that the technique does not easily address thinning of the work S.

On the other hand, the support pin 1 of the present invention is deformed so that the outside diameter increases by pinching the part excluding the staking part 4 of the fitting part 2 by a punch. Consequently, the fitting part 2 is closely attached to the hole S1 in the work S. As a result, high fastening strength and constant electric resistance are assured. In the present invention, the work S is sandwiched by both sides of the surface and the back side of the work S by the flange parts 3 and the staking parts 4 of the support pin 1. Therefore, even if the work s is thin, high support strength and uprightness can be assured.

(3)-2 Comparison with Patent Document 3

Patent document 3 discloses a support pin having an annular groove and a staking part having a triangle shape in cross section. With the configuration, a work is sandwiched by both sides of the surface and back side using the flange and the staking part of the support pin. Therefore, plastic-process of the annular groove and the staking part is very troublesome and it is estimated that mass production at low cost is difficult to be achieved. In contrast, the support pin 1 of the present invention has a simple shape, so that mass production at low cost can be realized.

(3)-3 Comparison with Patent Document 4

FIGS. 9B to 9D show a comparative example of applying the support pin of the patent document 4 to the back plate S. In the comparative example, in a state where the support pin 1′ is set in the back plate S, the staking part 4 enters the hole S1 in the back plate S. The diameter of the hole S1 in the back plate S is the same in the overall length.

In the comparative example, in the staking process, as shown by a solid arrow in FIG. 9D, the inner-radius part of the back plate S is deformed so as to escape to the annular recess 6. That is, the staking part 4 is deformed so as to escape to the inner side in the radial direction without spreading to the outside in the radial direction (in the staking part, the staking part and the back plate S tend to escape to the annular recess 6 for a relief place). It is understood that, due to the deformation, a phenomenon that a part of the staking part 4 becomes the burr 4c and enters the gap 10′ between the die 7 and the projected shaft 5 often occurs. More specifically, it can be said that, in the patent documents 4 and 5, formation of the staking part 4 in a triangle shape in cross section rather helps occurrence of a burr.

In contrast, in the embodiment, by the synergy effect of two elements that the staking part 4 is projected from the rear surface of the back plate S and the staking part 4 is disposed apart from the projected shaft 5 as much as possible by forming the flat bottom part 6a in the annular recess 6, occurrence of a burr is prevented reliably, pull-out of the support pin 1 after the staking is facilitated, and strength of attachment of the support pin 1 (resistance to come-off) is dramatically increased by deforming the staking part 4 in the flange shape.

In the embodiment of the patent document 4, as shown by an alternate long and short dash line in FIG. 9B, a tapered part 23 is formed in a part opposite to the flange 3 in the hole S1 in the work S, and the staking part 4 of the support pin 1′ is staked in the tapered part 23. However, the process of forming the tapered part 23 in the hole S1 in the work S is troublesome. In contrast, the hole S1 in the work S may be formed simply straight in the present invention, there is no need to process the work S.

(3)-4 Comparison with Patent Document 5

The cited document 4 is similar to the present invention with respect to the point that the work is sandwiched from both sides by the flange parts and the staking part. As for use, in the patent document 5 as shown as a comparative example in FIGS. 9E and 9F, the diameter of the hole S1 in the work S is set much larger than that of the fitting part 4, and an annular groove 24 is formed in the top face of the die 7. That is, in the patent document 5, by deforming the work S so that the inside diameter of the hole S1 becomes smaller, the staking part 4 is overlapped with the back side of the work S.

However, since deformation of the work S so that the inside diameter of the hole S1 becomes smaller is not reliable as described above, it is doubtful that the staking part 4 overlaps with the back side of the work S in reality. In addition, it is difficult to maintain the axis of the hole S1 in the work S to be almost the same as the axes of the die 7 and the support pin 1′. There is consequently the possibility that the core of the support pin 1′ and that of the hole S1 are largely deviated from each other after the staking process. There is also the possibility that the staking part 4 is firmly fit in the annular groove 24 and the work S cannot be taken out from the die 7 after the staking process.

In contrast, in the present invention, the work S is reliably sandwiched from both sides by the flange part 3 and the staking part 4, so that the core of the support pin 1 and that of the hole S1 in the work S do not deviate from each other. As described above, there is no problem in taking the work S out after the staking process.

(3)-5 Comparison with Patent Documents 6 to 9

In the patent documents 6 to 9, the head of the shaft is just closely attached to the surface of the work. The patent documents 6 to 9 are basically different from the present invention. The substantial difference between the patent documents 6 to 9 and the present invention and the patent documents 1 to 5 is that the support pin in any of the present invention and the patent documents 1 to 5 is held by the work so as not to be rotatable, but the support pin in any of the patent documents 6 to 9 does not always have a rotation stopping function.

### (4) Other Embodiments

FIGS. 7A to 7F show other embodiments of the annular recess 6 (in other words, other forms of the staking part 4). In a second embodiment shown in FIG. 7A, the bottom part 6a of the annular recess 6 is curved in a recessed shape toward the tip of the projected shaft 5 in vertical section view. The inner peripheral surface (tilted surface) of the annular recess 6 has a linear profile in vertical section view.

In a third embodiment shown in FIG. 7B, the bottom part 6a of the annular recess 6 is a flat surface, and the inner peripheral surface 4a of the annular recess 6 has a linear profile. In a fourth embodiment shown in FIG. 7C, both of the bottom part 6a in the annular recess 6 and the inner peripheral surface 4a are curved surfaces and are smoothly continuous.

In a fifth embodiment shown in FIG. 7D, the bottom part 6a of the annular recess 6 is a flat surface whereas the inner peripheral surface 4a is curved at a gentle curvature so as to be projected toward the projected shaft 5. In this case as well, it can be said that the bottom part 6a in the annular recess 6 and the inner peripheral surface 4a cross each other at an obtuse angle in vertical section view.

In a sixth embodiment shown in FIG. 7E, two modes of the bottom part 6a in the annular recess 6 are shown. Specifically, in the embodiment, the bottom part 6a crosses the outer peripheral surface of the projected shaft 5 at an obtuse angle in vertical cross section. On the other hand, in a state shown by an alternate long and short dash line, the bottom part 6a crosses the outer peripheral surface of the projected shaft 5 at an acute angle close to the right angle in vertical cross section. Also in the state of the alternate long and short dash line, durability of a mold (working tool) can be assured. However, it is unpreferable that the angle formed by the bottom part 6a and the projected shaft 5 is very small. From the viewpoint of practicality, the angle should be larger than about 70°.

In a seventh embodiment shown in FIG. 7F, the tip 4b of the staking part 4 is formed in a circular arc shape in vertical cross section. The configuration can be also applied to the other embodiments. The tip of the staking part 4 can be formed at an acute angle. However, from the viewpoint of mold detachability or the like at the time of processing, it is preferable to slightly provide a flat or curved surface. To make the mold detached easily, the outer peripheral surface of the fitting part 2 can be slightly tapered toward the tip of the projected shaft 5 (draft angle).

In an eighth embodiment shown in FIG. 8, the projected shaft 5 is formed in a stepped shape made of a large-diameter part 5a on the base end side and a small-diameter part 5b on the tip side. At the tip of the small-diameter part 5b, a positioning projection 5c is integrally formed. As understood from the example, the shape of the projected shaft 5 can be set arbitrarily as necessary.

1. A support pin to be fixed by staking, comprising:
a fitting part fit to a hole opened in a work made by a metal plate;
a flange part formed at the periphery of one end of the fitting part and overlapping one of surfaces of the work; and
a projected shaft provided integrally with a part on the side opposite to the flange part in the fitting part,
the diameter of the projected shaft being smaller than that of the fitting part so that an annular end surface is exposed in a part on the side opposite to the flange part in the fitting part,
an annular recess being formed in the annular end surface in the fitting part in a state where an inner peripheral surface of the annular recess coincides with an outer peripheral surface of the projected shaft,
an outer part of the annular recess being deformed when it is pinched in an axial direction so that it becomes a staking part which is partly spread outward, and
further, when the fitting part and the work are pinched in the axial direction by a die and a punch in a state where the fitting part is fit in the hole in the work, all or most of the fitting part including the flange part and the staking part sinking in the work,
wherein the annular recess has a bottom face continued to the outer periphery of the projected shaft and a tilted inner peripheral surface continued from the bottom face and becomes shallower toward the outer periphery of the staking part,
the bottom face and the tilted surface are continued indirectly in a recessed state toward the tip of the projected shaft in vertical section view, so that the annular recess has a trapezoidal shape or a shape close to the trapezoidal shape in vertical section view, and
when an overall length of the fitting part is L0, a thickness of the work is T1, a length in the axial direction from a top surface of the flange part to the bottom face of the annular recess is L2, and a length in the axial direction from a seating surface of the flange part to the tip of the staking part is L1, L0 is larger than T1 and L2, L2 is almost equal to or smaller than T1, and L1 is larger than T1.

2. The support pin to be fixed by staking according to claim 1, wherein the bottom face of the recess is flat, so that a vertical-sectional shape of the recess is an almost trapezoidal shape.

3. A back plate for a flat display panel, wherein a number of the support pins according to claim 1 are attached by staking, and all or most of the fitting part including the flange and the staking part in the support pin sink in the back plate.

4. A back plate for a flat display panel, wherein a number of the support pins according to claim 2 are attached by staking, and all or most of the fitting part including the flange and the staking part in the support pin sink in the back plate.
